(19) United States
(12) Patent Application Publication
(10) Pub. No.: US 2024/0367599 A1
(43) Pub. Date: Nov. 7, 2024

(54) Method and Device for Detecting Hand Contact with a Steering Wheel of a Vehicle

(71) Applicant: Volkswagen Aktiengesellschaft, Wolfsburg (DE)

(72) Inventors: Jonas Kaste, Alfeld (Leine) (DE); Daniel Münning, Braunschweig (DE); Felix Stahl, Braunschweig (DE)

(73) Assignee: Volkswagen Aktiengesellschaft, Wolfsburg (DE)

(21) Appl. No.: 18/653,417

(22) Filed: May 2, 2024

(30) Foreign Application Priority Data
May 3, 2023 (DE) 10 2023 204 053.0

(51) Int. Cl. B60R 16/027; B60R 16/023; B62D 1/04; G06N 20/00

(52) U.S. Cl. CPC B60R 16/027; B60R 16/0232; B62D 1/046; G06N 20/00

(57) ABSTRACT

The disclosure relates to a method for detecting hand contact with a steering wheel of a vehicle, wherein a decision, based on at least detected and/or received status data of a steering system of the vehicle, is made by means of at least one trained machine learning method as to whether at least one hand is in contact with the steering wheel or not, wherein an actuation of at least one control element arranged on the steering wheel is taken into account as an input variable of the at least one trained machine learning method, and wherein a decision signal is generated and provided.

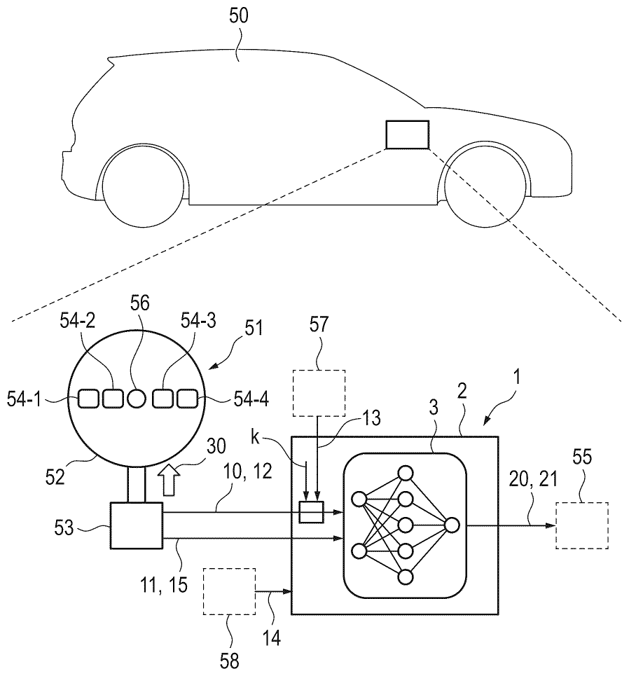

### CROSS-REFERENCE TO RELATED APPLICATIONS

This application claims priority to German Patent Application No. DE 10 2023 204 053.0, filed on May 3, 2023 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a method and a device for detecting hand contact with a steering wheel of a vehicle.

In modern vehicles, drivers are supported by driver assistance systems that provide driver assistance functions, such as automated or partially automated longitudinal and/or lateral guidance of the vehicle. At present, it is still usually the case that drivers have to place their hands on the steering wheel at regular intervals to enable automated or semi-automated operation. Failure to do so deactivates the driver assistance function. Various sensors and/or methods could be used to detect that at least one hand is on the steering wheel (also referred to as ‘hands-on detection’).

A capacitive sensor on a steering wheel of the vehicle may, for example, be used to determine whether or at least one of the driver's hands is on the steering wheel. For example, a multi-level status (e.g., no contact, slightly gripped on the left/right up to strongly gripped bilaterally, etc.), which is transmitted, for example, to support functions such as a longitudinal and/or lateral guidance assistance system, can be determined from the sensor data recorded by the capacitive sensor. For example, such a status can be fed as an input to an adaptive cruise control system (ACC), wherein an acceleration process for following a vehicle in front is, for example, enabled when contact between at least one hand and the steering wheel is detected. Driver observation cameras that can detect driver activity could also be used.

In addition, methods are conceivable that detect driver activity, particularly in relation to hands-on detection, using an artificial intelligence method (machine learning) or rule-based approaches. For example, an artificial intelligence method, in particular an artificial neural network, can be trained to carry out a hands-on detection based on a torque detected on a steering system, a steering angle detected and/or changes in these variables. The rule-based approach, on the other hand, may passively evaluate steering signals (e.g., a steering torque, a steering speed and/or a steering angle) against threshold values and/or signal curves and/or actively works with a torque application, in which a test signal is applied to the steering wheel by means of an actuator, which is intended to cause a counter torque of hands arranged on the steering wheel, which can be detected by means of a sensor. As soon as such a counter torque is detected, it is assumed that at least one hand is positioned on the steering wheel.

### SUMMARY

A need exists to improve a method and a device for detecting contact between hands and a steering wheel of a vehicle. The need is addressed by the subject matter of the independent claims. Embodiments of the invention are described in the dependent claims, the following description, and the drawings.

### BRIEF DESCRIPTION OF THE DRAWING

The FIGURE shows a schematic representation illustrating embodiments of the device for detecting contact of hands with a steering wheel of a vehicle.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method for detecting contact of hands with a steering wheel of a vehicle is provided, wherein a decision or determination, based on at least detected and/or received status data of a steering system of the vehicle, is made by means of at least one trained machine learning method as to whether at least one hand is in contact with the steering wheel or not. In some embodiments, an actuation of at least one control element arranged on the steering wheel is taken into account as an input variable of at least one trained machine learning method. In some embodiments, a decision signal is generated and provided, for example to a vehicle assistance system, such as a longitudinal and/or lateral guidance assistance system or other driver support systems.

In some embodiments, a device for detecting contact of hands with a steering wheel of a vehicle is provided, comprising one or more processors (also referred to herein as ‘data processing apparatus’), wherein the one or more processors are set up to receive recorded and/or queried status data of a steering system of the vehicle and to provide at least one trained machine learning method, which makes a determination/decision, based on at least the received status data, as to whether or not at least one hand is in contact with the steering wheel In some embodiments, an actuation of at least one control element arranged on the steering wheel is taken into account as an input variable of at least one trained machine learning method In some embodiments, a decision signal is provided, for example to a vehicle assistance system, such as a longitudinal and/or lateral guidance assistance system or other driver support systems.

The method and the device in some embodiments enable an actuation of at least one control element arranged on the steering wheel to be taken into account as an input variable in determining whether a hand is in contact with the steering wheel or not (hands-on detection). In some embodiments, the at least one trained machine learning method is provided with a further input data or, respectively, a further dimension of input data. All in all, this makes the determination in some embodiments more robust because more data can be taken into account.

The status data of the steering system comprise in some embodiments a detected steering torque and/or a detected steering angle. In some embodiments, changes to these variables can be taken into account. The status data and the input variable are fed as input data to the trained machine learning method.

In some embodiments, a trained machine learning method is a trained neural network, for example a trained deep neural network. The trained machine learning method is trained to make a determination or, respectively, estimate, whether at least one hand is on the steering wheel or not, based on the status data of the steering system. A result may be provided in the form of a decision signal. The decision may in some embodiments include at least two possible values (e.g., contact Yes/No or, respectively, corresponding values of a data packet or signal level). In principle, however, different elements of the determination can also be shown in some embodiments (e.g., no hand on the steering wheel, one hand on the steering wheel, both hands on the steering wheel, etc.). The machine learning method is trained in a typical manner based on training data. In some embodiments, in each case pairs of status data as input data and known decision data (contact yes/no etc.) may be used as training data as output data or, respectively, as ground truth. Furthermore, information on the actuation of at least one control element may also be used here as the input data, i.e., the information on whether at least one control element is actuated or not may in some embodiments also be taken into account as the input data during training (and later when applying the machine learning method).

A control element arranged on the steering wheel may in some embodiments be one or more of: a button, a slider, a key, and a potentiometer. Examples of control elements on the steering wheel are a telephone control (e.g., buttons for “Answer call”, “Hang up”, etc.), a multimedia control (e.g., buttons for “Volume up”, “Volume down”, “Continue”, “Mute”, etc.), a cruise control (e.g., buttons for “SET”, “RESUME”, etc.) and gearshift levers (e.g., levers or buttons for “Go up a gear”, “Go down a gear”, Tiptronic®, etc.).

Parts of the device, especially the trajectory planning apparatus, may in some embodiments be constructed separately or collectively as a combination of hardware and software, for example as a program code executed on a microcontroller or microprocessor. Parts may, however, also be designed individually or collectively as an application-specific integrated circuit (ASIC) and/or field-programmable gate array (FPGA).

In some embodiments, provision is made for at least a portion of the control elements arranged on the steering wheel to be taken into account individually. This enables the individual characteristics of each control element on the steering wheel to be taken into account when a decision is made. In some embodiments, all control elements can be taken into account individually in each case. The trained machine learning method then receives additional information as an input data which uniquely identifies at least one actuated control element. The additional information may improve the decision-making process, making it in particular more differentiated and therefore more robust. When one machine learning method at least is being trained, the information uniquely identifying at least one control element on the steering wheel may be taken into account accordingly in some embodiments.

In some embodiments, provision is made for at least a portion of the control elements arranged on the steering wheel and grouped by class to be taken into account individually. This may reduce the time and effort involved in training the machine learning method, as training data no longer has to be generated and provided for all control elements but only for the groups. This reduces the time and effort and costs of the training phase. In some embodiments, all control elements on the steering wheel grouped by class can be taken into account. For example, control elements can be grouped by class depending on a type of the respective control element and/or a position of the respective control element on the steering wheel.

In some embodiments, a test signal is applied to the steering wheel when an actuation of at least one control element is detected, wherein a counter torque caused by said actuation is detected and taken into account in the determination. This enables a check to be made whether a hand is on the steering wheel or not when at least one control element is actuated. The actuation of at least one control element can also be improved thereby, detected for example in the form of a counter torque, and taken into account in the determination. This enables decision-making to be further differentiated and thus made more robust.

In some embodiments, provision is made for one type of at least one control element actuated to be taken into account. This enables the type of at least one control element actuated to be taken into account as well when making a determination. For example, one type contains at least one of the following types of information: mechanical button, mechanical potentiometer, mechanical lever, capacitive button, etc. The determination can thereby be further differentiated and made more robust.

In some embodiments, provision is made for taking into account a position of at least one control element on the steering wheel and/or a distance of at least one actuated control element from an axis of rotation of the steering wheel. This enables the position and/or distance to be taken into account when making a decision especially when applying a test signal. The underlying idea is that when the test signal is applied, a counter torque with the same actuating force, with which at least one actuating element is actuated, is different due to the position-related and/or distance-related leverage effect. For example, one button may be 5 cm away from the axis of rotation, whereas another button may be 10 cm away. If the test signal (torque) is the same size, a counter torque recorded with the same actuating force on the buttons will differ by a factor of 2 because of the different lever arm. This enables the determination to be further differentiated and thus made more robust.

In some embodiments, provision is made for taking into account a correction factor based on at least one control element actuated. This enables a different leverage effect to be taken into account and/or corrected, particularly when the test signal is applied. For example, it may be possible to correct a detected counter torque using the correction factor and to feed the corrected counter torque to the trained machine learning method as input data for decision making. In the preceding example, for example, a correction factor of 2 could be provided for the button located at a distance of 5 cm from the axis of rotation. A detected counter torque is doubled as a result which is therefore equal to a detected counter torque on the other button with the same actuating force. Such a correction factor can, for example, be determined and provided based on the position and/or distance of at least one actuated control element on the steering wheel. For example, a rule specified for the determination can be stored in the one or more processors. The correction factor may, for example, be a function of the distance: k=f (d)=c/d, where k is the correction factor, c is a (normalization) constant and d is the distance from the axis of rotation. This enables the determination to be further differentiated and thus made more robust.

In some embodiments, provision is made for taking into account a driver profile of a driver when considering at least one control element actuated. This enables individual driver characteristics to be taken into account. Individual characteristics (big person, small person) in particular may influence the strength of actuation. The driver profile can be selected either by the driver themselves or it can be automatically selected based on sensor data detected (e.g. from a weight sensor in the driver's seat and/or a driver camera, etc.). In particular, the correction factor described in the above paragraph can be determined, selected and/or adjusted depending on the driver profile. This enables decision-making to be further differentiated and thus made more robust.

In some embodiments, provision is made for detecting a driver by means of at least one driver camera, wherein at least one detected image from at least one driver camera is also evaluated and taken into account. This can be used, for example, to determine the driver profile described in the preceding paragraph. In addition, a driver's intention can be determined and taken into account based, for example, on at least one recorded image (unintentional or intentional operation of the control element, driver facing towards or away from the steering wheel, etc.). An evaluation result is also fed to the trained machine learning method as input data and taken into account in the decision-making process. This enables decision-making to be further differentiated and thus made more robust.

Additional features of the design of the device are set out in the description of embodiments of the method. The benefits of the device are in each case the same as in the embodiments of the method.

The FIGURE shows a schematic diagram illustrating embodiments of the device 1 for detecting contact of hands with a steering wheel 52 of a vehicle 50. The device 1 is arranged in particular in the vehicle 50. The device 1 is set up to carry out the method described in this disclosure. The method is explained in more detail below by reference to the device 1.

The device 1 comprises a data processing apparatus 2. The data processing apparatus 2 comprises, for example, at least one computing device (not shown) and at least one memory (not shown). The at least one computing device performs the computing operations required to carry out the process steps of the method.

The data processing apparatus 2 is set up to receive recorded and/or queried status data 10 of a steering system 51 of the vehicle 50, for example from a steering control 53, and to provide at least one trained machine learning method 3 which, on the basis of at least the received status data 10, makes a decision 20 as to whether or not at least one hand is in contact with the steering wheel 52. The status data 10 can include, for example, a recorded steering torque and/or a recorded steering angle and/or changes in these variables. The at least one trained machine learning method 3 comprises in particular at least one trained neural network, in particular a trained deep neural network.

Provision is made for an actuation of at least one control element 54-x arranged on the steering wheel 52 to be taken into account as an input variable 11 of the at least one machine learning method 3. To this end, the steering control 53 can transmit a corresponding actuation signal 15 for the input variable 11 to the data processing apparatus 2, which encodes the actuation of the at least one control element 54-x.

The data processing apparatus 2 is also set up to provide a decision signal 21 based on the decision made 20.

The decision signal 21 can, for example, be fed to a driver assistance system 55 of the vehicle 50, which is activated or deactivated depending on the decision signal 21. Such a driver assistance system 55 may, for example, be an adaptive cruise control (ACC), wherein a following function, in which the vehicle 50 after coming to a standstill is enabled to follow a vehicle in front, is activated or deactivated depending on whether a hand is in contact with the steering wheel 52 or not.

Provision can be made for at least a portion of the control elements 54-x arranged on the steering wheel 52 to be taken into account individually. The input variable 11 or, respectively, the actuation signal 15 then additionally comprises information that uniquely identifies the control element actuated 54-x.

Provision can be further made for at least a portion of the control elements 54-x arranged on the steering wheel 52 grouped by class to be taken into account. For example, provision may be made for considering the respective externally arranged control elements 54-1, 54-4 in one class and for considering the respective internally arranged control elements 54-2, 54-3 in another class. The respective control elements 54-x will then no longer be considered individually, but only according to their respective class.

Provision can be made for applying a test signal 30 to the steering wheel 52 when an actuation of the at least one control element 54-x is detected, wherein a counter torque 12 caused thereby is detected and taken into account in the decision 20. The signal is applied by means of an actuator (not shown) of the steering system 51 in a manner known per se. The counter torque 12 can be detected, for example, by means of a torque sensor (not shown) of the steering system 51.

Provision can be made for taking into account a type of the at least one control element 54-x actuated. For example, the control elements 54-1, 54-2 can be designed as mechanical buttons, whereas the control elements 54-3 and 54-4 can be designed as capacitive buttons. This difference is then fed to the trained machine learning method 3 as additional information or, respectively, as input data. Either the type can be coded as information in the input variable 11 or the type stored individually or in groups for each control element 54-x in the memory of the data processing apparatus 2 and determined on the basis of information that uniquely identifies the respective control element 54-x individually or in groups. When training the machine learning method 3, the type of control element 54-x is taken into account accordingly.

Provision can be made for taking into account a position of the at least one control element 54-x on the steering wheel 52 and/or a distance of the at least one control element 54-x actuated from an axis of rotation 56 of the steering wheel 52. Either the position and/or the distance can be coded as information in the input variable 11 or the position and/or the distance can be stored for each control element 54-x individually or in groups in the memory of the data processing apparatus 2 and determined on the basis of information that uniquely identifies the respective control element 54-x individually or in groups

Provision can be made for selecting and taking into account a correction factor k based on the at least one control element 54-x actuated. The correction factor k can, for example, be determined on the basis of information that uniquely identifies the respective actuating element 54-x individually or in groups.

Alternatively, the correction factor k can, for example, be determined on the basis of a respective position and/or a respective distance of the at least one actuating element 54-x actuated. Provision can be made for correcting the counter torque 12 detected, for example, by means of the control element-dependent correction factor k. The correction factor k is in particular a function of the position and/or the distance.

Provision can be made for taking into account a driver profile 13 of a driver when considering the at least one control element 54-x actuated. In particular, the correction factor k as a function of the driver profile 13 can be selected or information on the driver profile 13 used directly as input to the trained machine learning method 3. The driver profile 13 can be selected by a driver, for example. Alternatively, the driver profile 13 can also be provided by a vehicle control unit 57.

Provision can be made for recording a driver by means of at least one driver camera 58, wherein at least one recorded image 14 of the at least one driver camera 58 is additionally evaluated and taken into account. The evaluation can include, for example, detection of the direction of gaze and/or detection of a driver's intention, which is taken into account by the trained machine learning method 3 as part of the decision-making or, respectively, application of the trained machine learning method 3 and fed to the trained machine learning method 3 as input data for this purpose.

### LIST OF REFERENCE NUMERALS

1 Device
2 Data processing apparatus
3 Trained machine learning method
10 Status data
11 Input variable
12 Counter torque
13 Driver profile
14 Recorded image
15 Actuation signal
20 Decision
21 Decision signal
30 Test signal
50 Vehicle
51 Steering system
52 Steering wheel
53 Steering control
54 Control element
55 Driver assistance system
56 Axis of rotation
57 Vehicle control
58 Driver camera
k Correction factor

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

1. A method for detecting contact of hands with a steering wheel of a vehicle, comprising:
determining, based on at least detected and/or received status data of a steering system of the vehicle and using at least one trained machine learning method, whether at least one hand is in contact with the steering wheel or not, wherein an actuation of one or more control elements arranged on the steering wheel is taken into account as an input variable of at least one trained machine learning method; and
generating and providing a decision signal.

2. The method of claim 1, wherein multiple of the one or more control elements arranged on the steering wheel are taken into account individually.

3. The method of claim 1, wherein the one or more control elements are grouped into one or more classes and the one or more classes of control elements are taken into account.

4. The method of claim 1, wherein when an actuation of the one or more control elements is detected, a test signal is applied to the steering wheel, wherein a counter torque caused thereby is detected and taken into account in the decision.

5. The method of claim 1, wherein a type of the one or more control elements is taken into account.

6. The method of claim 1, wherein a position of the one or more control elements on the steering wheel and/or a distance of the one or more actuated control elements from an axis of rotation of the steering wheel is taken into account.

7. The method of claim 1, wherein a correction factor is taken into account based on the one or more actuated control elements.

8. The method of claim 1, wherein a driver profile of a driver is also taken into account when the one or more actuated control elements is taken into account.

9. The method of claim 1, wherein a driver is detected using at least one driver camera, wherein at least one detected image of the at least one driver camera is additionally evaluated and taken into account.

10. A device for detecting hand contact with a steering wheel of a vehicle, comprising one or more processors to:
receive recorded and/or queried status data of a steering system of the vehicle;
provide at least one trained machine learning method, which trained machine learning method is configured to determine, based on at least the received status data, whether at least one hand is in contact with the steering wheel or not, wherein an actuation of one or more control elements arranged on the steering wheel is taken into account as an input variable of the at least one trained machine learning method; and to
provide a decision signal.

11. The method of claim 2, wherein the one or more control elements are grouped into one or more classes and the one or more classes of control elements are taken into account.

12. The method of claim 2, wherein when an actuation of the one or more control elements is detected, a test signal is applied to the steering wheel, wherein a counter torque caused thereby is detected and taken into account in the decision.

13. The method of claim 3, wherein when an actuation of the one or more control elements is detected, a test signal is applied to the steering wheel, wherein a counter torque caused thereby is detected and taken into account in the decision.

14. The method of claim 2, wherein a type of the one or more control elements is taken into account.

15. The method of claim 3, wherein a type of the one or more control elements is taken into account.

16. The method of claim 4, wherein a type of the one or more control elements is taken into account.

17. The method of claim 2, wherein a position of the one or more control elements on the steering wheel and/or a distance of the one or more actuated control elements from an axis of rotation of the steering wheel is taken into account.

18. The method of claim 3, wherein a position of the one or more control elements on the steering wheel and/or a distance of the one or more actuated control elements from an axis of rotation of the steering wheel is taken into account.

19. The method of claim 4, wherein a position of the one or more control elements on the steering wheel and/or a distance of the one or more actuated control elements from an axis of rotation of the steering wheel is taken into account.

20. The method of claim 5, wherein a position of the one or more control elements on the steering wheel and/or a distance of the one or more actuated control elements from an axis of rotation of the steering wheel is taken into account.
